(19) United States
(12) Patent Application Publication
(10) Pub. No.: US 2007/0017763 A1
(43) Pub. Date: Jan. 25, 2007

(54) Energy conversion device including a piston without O-rings

(76) Inventor: Yao-Chang Lin, Taichung City (TW)

Correspondence Address: GREENBLUM & BERNSTEIN, P.L.C., 1950 ROLAND CLARKE PLACE, RESTON, VA, 20191, US

(21) Appl. No.: 11/183,981

(22) Filed: Jul. 19, 2005

(51) Int. Cl. F16F 9/43

(52) U.S. Cl. 188/322.18; 267/64.28

(57) ABSTRACT

An energy conversion device includes a gas cylinder having a cylinder body, and a piston guided to move along a direction. The cylinder body includes an annular partition wall unit extending from a base plate and defining a piston chamber. The piston includes a plug and an annular fence unit. Clearances are formed between the plug and the partition wall unit, and between the partition wall unit and the fence unit such that the partition wall unit does not contact the plug and the fence unit. The plug, the fence unit and the partition wall unit define a surrounding chamber unit around the piston chamber. When the plug moves toward the base plate to compress gas within the piston chamber, gas within the surrounding chamber unit is also compressed to thereby establish a gas-tight seal between the plug and the partition wall unit.

### BACKGROUND OF THE INVENTION

1. Field of the Invention

This invention relates to an energy conversion device, such as an engine and a compressor, and more particularly to an energy conversion device including a gas cylinder, in which there is no O-ring between a piston and an annular inner surface of a cylinder body.

2. Description of the Related Art

Referring to FIG. 1, a conventional engine 10 includes a cylinder body 11, a piston 12, a connecting rod 13 and a crankshaft 14. The cylinder body 11 defines a combustion chamber 111, a lower end of which is delimited by the piston 12, and further has an ignition member 112, an intake port 113 and an exhaust port 114. Two O-rings 121, 122 are sleeved on the piston 12, and are in slidable contact with an annular inner surface of the cylinder body 11 for establishing an airtight seal and for lubricating purposes. Although the O-rings 121, 122 are made of wear-resistant materials, they nevertheless experience wear, thereby resulting in escape of air from the air chamber 111. Furthermore, when the engine 10 overheats due to frequent friction produced between the inner surface of the cylinder body 11 and the O-rings 121, 122, the piston 12 expands and melts along an outer periphery thereof. In extreme case, the piston 12 becomes stuck within the cylinder body 11. This results in failure of the engine 10.

### SUMMARY OF THE INVENTION

The object of this invention is to provide an energy conversion device that includes a gas cylinder, in which there is no friction produced between a piston and an annular inner surface of a cylinder body defining an air chamber.

According to an aspect of this invention, an energy conversion device includes a gas cylinder, a shaft-supporting body and a crankshaft. The gas cylinder has a cylinder body fixed to the shaft-supporting body, and a piston connected to the crankshaft and guided to move along a direction. The cylinder body includes an annular partition wall unit extending from a base plate toward the piston and defining a piston chamber. The piston includes a plug and an annular fence unit that extend from a plate body toward the base plate. The fence unit is disposed around the plug. Clearances are formed between the plug and the partition wall unit, and between the partition wall unit and the fence unit such that the partition wall unit does not contact the plug and the fence unit. The plug, the fence unit and the partition wall unit define a surrounding chamber unit around the piston chamber. When the plug moves toward the base plate to compress gas within the piston chamber, gas within the surrounding chamber unit is also compressed to thereby establish a gas-tight seal between the plug and the partition wall unit.

According to another aspect of this invention, an energy conversion device includes two gas cylinders, a shaft-supporting body and a crankshaft. Each of the gas cylinders has a cylinder body fixed to the shaft-supporting body, and a piston connected to the crankshaft and guided to move along a direction. Each of the cylinder bodies includes an annular partition wall unit extending from a base plate toward a corresponding one of the pistons and defining a piston chamber. Each of the pistons includes a plug and an annular fence unit that extend from a plate body toward a corresponding one of the base plates. Each of the fence units is disposed around a corresponding one of the plugs. In each of the gas cylinders, clearances are formed between the plug and the partition wall unit, and between the partition wall unit and the fence unit such that the partition wall unit does not contact the plug and the fence unit. The plug, the fence unit and the partition wall unit of each of the gas cylinders define a surrounding chamber unit around the piston chamber in a corresponding one of the gas cylinders. In each of the gas cylinders, when the plug moves toward the base plate to compress gas within the piston chamber, gas within the surrounding chamber unit is also compressed to thereby establish a gas-tight seal between the plug and the partition wall unit.

According to still another aspect of this invention, a gas cylinder has a cylinder body, and a piston guided to move along a direction. The cylinder body includes an annular partition wall unit extending from a base plate toward the piston and defining a piston chamber. The piston includes a plug and an annular fence unit that extend from a plate body toward the base plate. The fence unit is disposed around the plug. Clearances are formed between the plug and the partition wall unit, and between the partition wall unit and the fence unit such that the partition wall unit does not contact the plug and the fence unit. The plug, the fence unit and the partition wall unit define a surrounding chamber unit around the piston chamber. When the plug moves toward the base plate to compress gas within the piston chamber, gas within the surrounding chamber unit is also compressed to thereby establish a gas-tight seal between the plug and the partition wall unit.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a sectional view of a conventional energy conversion device in the form of an engine;

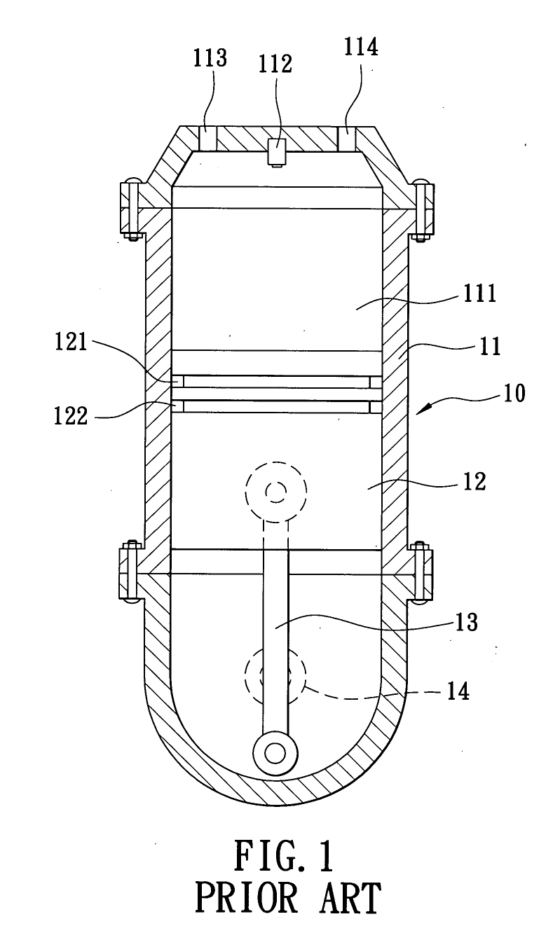

FIG. 2 is a sectional view of the first preferred embodiment of an energy conversion device according to this invention;

FIG. 3 is a fragmentary, partly sectional, exploded perspective view of a gas cylinder and a piston of the first preferred embodiment;

FIG. 4 is a sectional view of the first preferred embodiment, illustrating how a plug is moved toward a base plate so as to compress gas within a piston chamber and a surrounding chamber unit;

FIG. 5 is a fragmentary sectional view of the first preferred embodiment, illustrating how clearances are formed between the plug and an annular partition wall unit and between the partition wall unit and an annular fence unit such that the partition wall unit does not contact the plug and the fence unit;

FIG. 6 is a sectional view of the second preferred embodiment of an energy conversion device according to this invention;

FIG. 7 is a sectional view of the third preferred embodiment of an energy conversion device according to this invention;

FIG. 8 is a sectional view of the fourth preferred embodiment of an energy conversion device according to this invention;

FIG. 9 is a sectional view of the fifth preferred embodiment of an energy conversion device according to this invention;

FIG. 10 is a sectional view of the fifth preferred embodiment, illustrating how a plug is moved so as to compress gas within an annular upper gas chamber; and

FIG. 11 is a sectional view of the sixth preferred embodiment of an energy conversion device according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

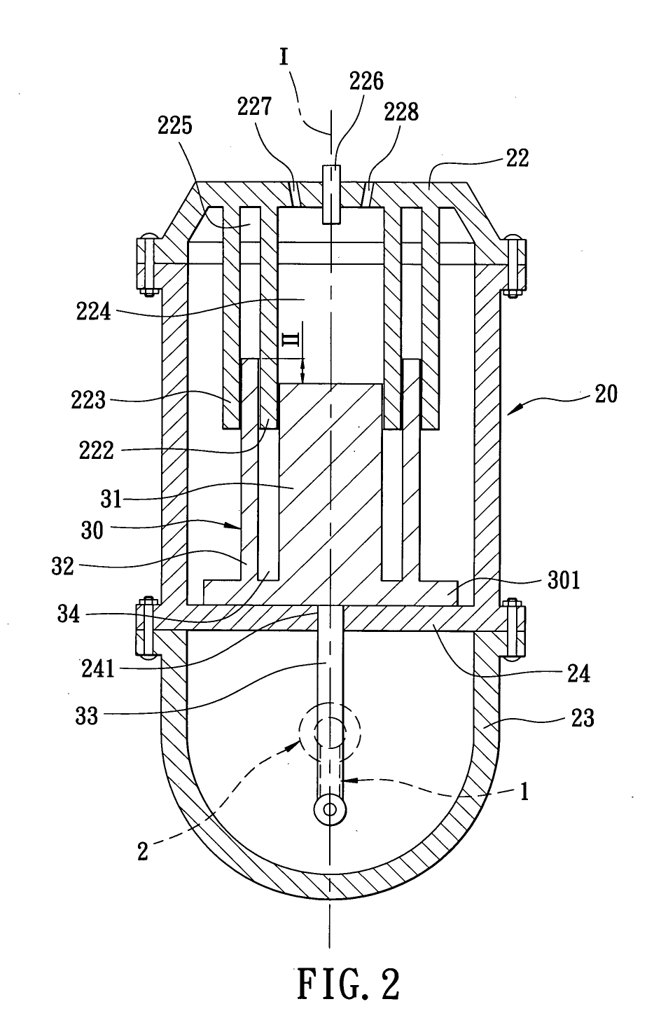

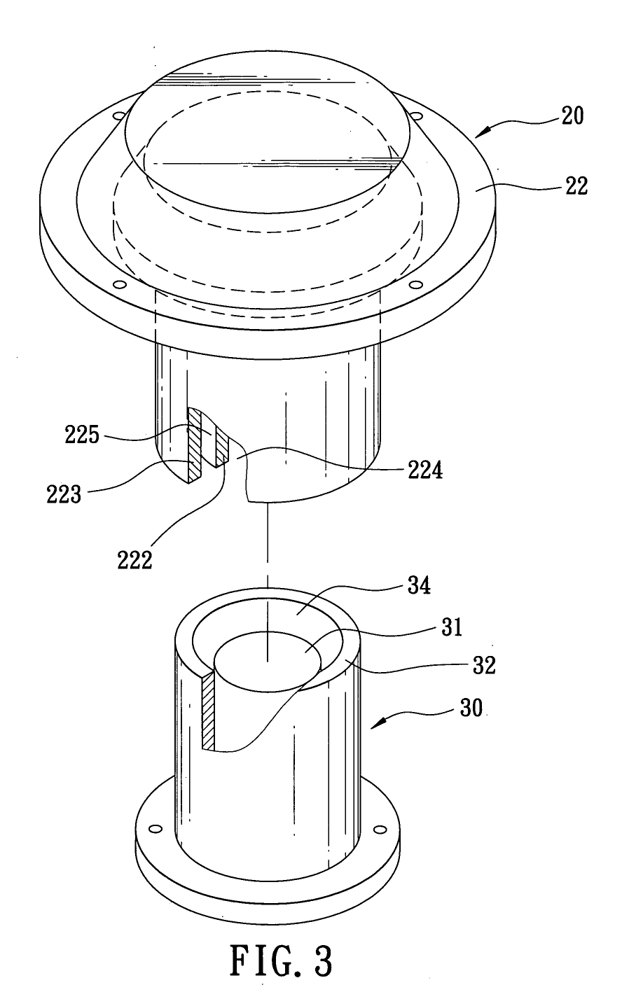

Referring to FIGS. 2 and 3, the first preferred embodiment of an energy conversion device according to this invention is configured as a single cylinder engine, and includes a gas cylinder consisting of a cylinder body 20 and a piston 30, a shaft-supporting body 23, a connecting rod 1, a crankshaft 2, and a surrounding chamber unit defined between the cylinder body 20 and the piston 30. The crankshaft 2 is journalled within the shaft-supporting body 23. The connecting rod 1 interconnects the piston 30 and the crankshaft 2.

The cylinder body 20 includes a base plate 22 having an inner side surface that is formed with an annular partition wall unit, and a bottom wall 24 opposite to the base plate 22 and having a central hole 241 formed therethrough. The shaft-supporting body 23 is connected threadedly to the bottom plate 24. The partition wall unit includes a pair of coaxial cylindrical first and second partition walls 222, 223 defining an annular first upper gas chamber 225 therebetween and extending from the base plate 22 toward the piston 30 along an axis (I) of the cylinder body 20. The first partition wall 222 defines a cylindrical piston chamber 224, and is surrounded by the second partition wall 223. An ignition member or spark plug 226 extends through and is secured to the center of the base plate 22. The base plate 22 is formed with an intake port 227 and an exhaust port 228.

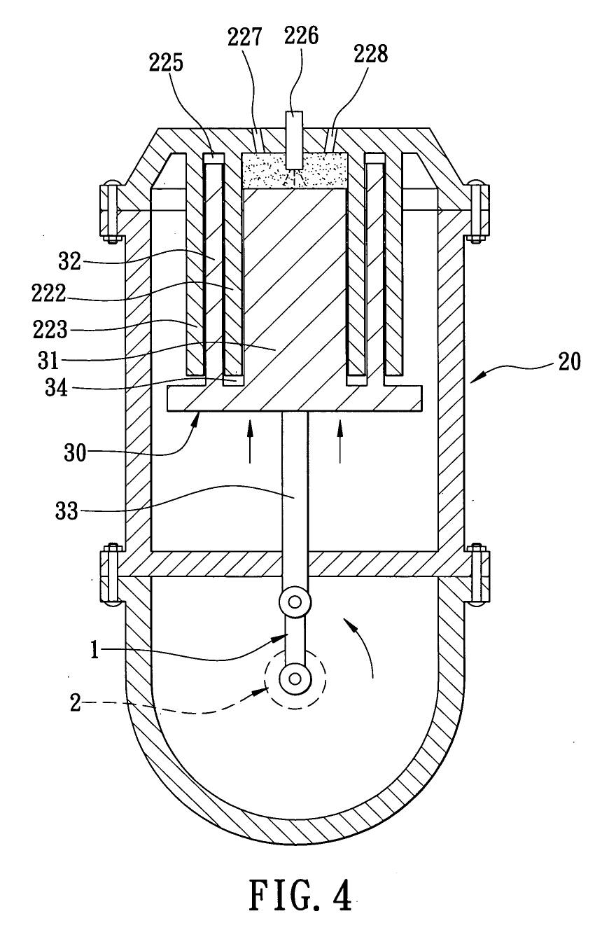

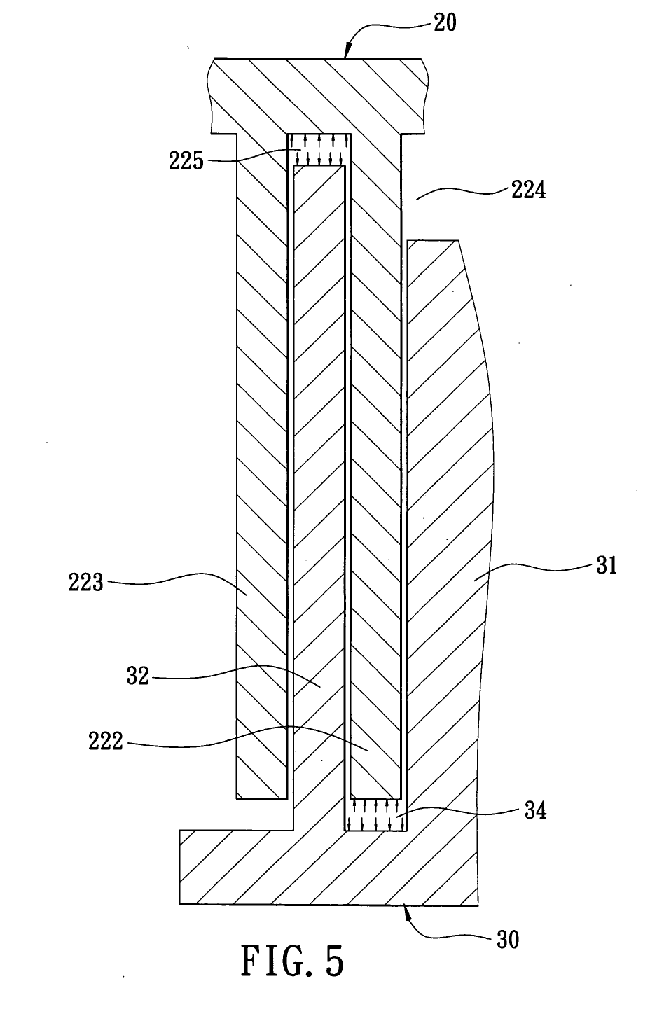

The piston 30 includes a circular plate body 301 having an inner side surface that is formed with a cylindrical plug 31 extending from the center thereof into the piston chamber 224, and a fence unit. The fence unit includes an annular fence 32 disposed coaxially around and spaced apart from the plug 31 and extending from the plate body 301 into the first upper gas chamber 225. The plate body 301 further has an outer side surface that is formed with a fixed guide rod 33 extending along the axis (I) of the cylinder body 20 and through the central hole 241 in the second bottom wall 24. The guide rod 33 engages fittingly and is movable within the hole 241 so as to guide the piston 30 to move along the axial direction of the cylinder body 20. The hole 241 and the guide rod 33 constitute cooperatively a guiding unit. The connecting rod 1 is connected pivotally to the guide rod 33 so that straight reciprocal movement of the piston 30 within the cylinder body 20 can be converted into rotation of the crankshaft 2. The plug 31 is movable within the piston chamber 224 in the cylinder body 20, and is coaxial with the first and second partition walls 222, 223 of the cylinder body 20. The plug 31 and the first fence 32 define an annular first lower gas chamber 34 therebetween. The first upper gas chamber 225 and the first lower gas chamber 34 constitute the surrounding chamber unit, and are disposed around the piston chamber 224. The plug 31 has a diameter that is slightly smaller than the inner diameter of the first partition wall 222 such that an annular clearance is formed therebetween. Similarly, annular clearances are formed between the first partition wall 222 and the first fence 32, and between the first fence 32 and the second partition wall 223. As such, contact among the plug 31, the fence 32, and the first and second partition walls 222, 223 can be prevented. The first fence 32 has an axial length greater than that of the plug 31 to thereby form a length difference (II) therebetween. When the plug 31 moves toward the base plate 22 so as to compress gas within the piston chamber 224, gas within the first upper gas chamber 225 and the first lower gas chamber 34 is also compressed, as shown in FIGS. 4 and 5. Thus, a gas-tight seal is established between the plug 31 and the first partition wall 222 so as to prevent escape of gas from the piston chamber 224.

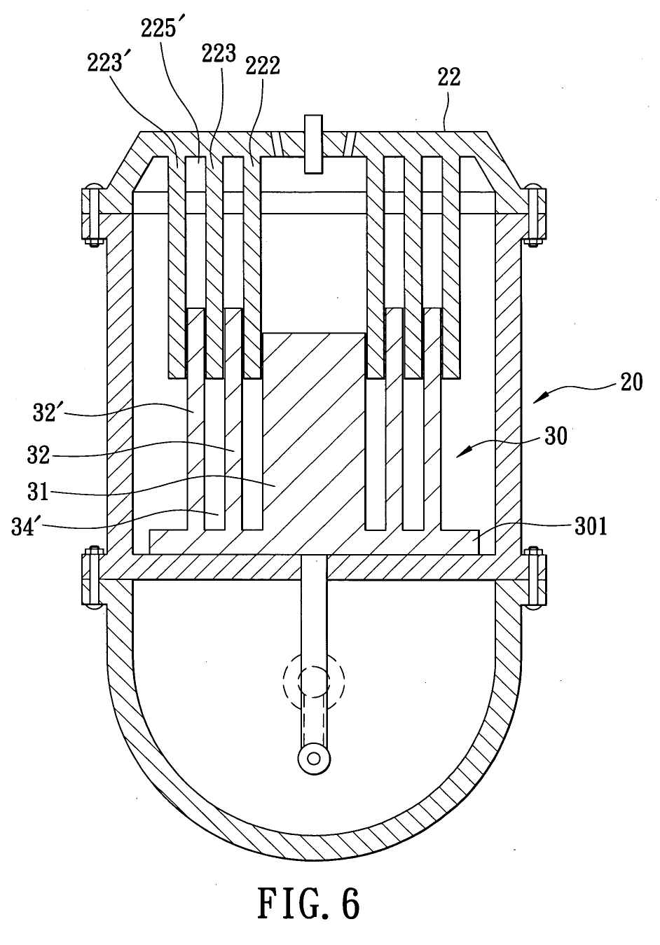

FIG. 6 shows the second preferred embodiment of an energy conversion device according to this invention, which is similar in construction to the first preferred embodiment except that an annular third partition wall 223′ and an annular second fence 32′ are further included respectively in the partition wall unit and the fence unit. The third partition wall 223′ extends from the inner side surface of the base plate 22 toward the piston 30, and is disposed coaxially around the second partition wall 223 so as to define an annular second upper gas chamber 225′ between the second and third partition walls 223, 223′. The axial length of the third partition wall 223′ is equal to that of the second partition wall 223. The second fence 32′ extends from the inner side surface of the plate body 301 into the second upper gas chamber 225′, and is disposed coaxially around the first fence 32. The first and second fences 32, 32′ define an annular second lower gas chamber 34′ therebetween. The axial length of the second fence 32′ is equal to that of the first fence 32. Clearances are formed between the second fence 32′ and the second partition wall 223, and between the second fence 32′ and the third partition wall 223′. This prevents contact between the second fence 32′ and the second partition wall 223, and between the second fence 32′ and the third partition wall 223′. The second upper gas chamber 225′ and the second lower gas chamber 34′ form portions of the surrounding chamber unit.

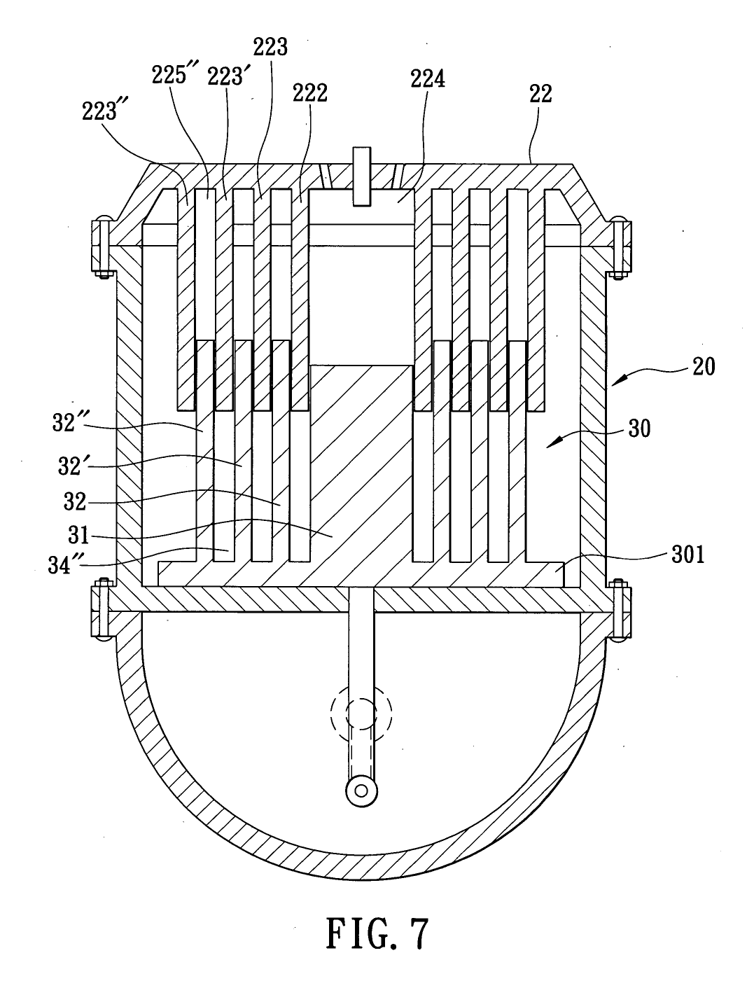

FIG. 7 shows the third preferred embodiment of an energy conversion device according to this invention, which is similar in construction to the second preferred embodiment except that an annular fourth partition wall 223″ and an annular third fence 32″ are further included respectively the partition wall unit and the fence unit. The fourth partition wall 223Δ extends from the inner side surface of the base plate 22 toward the piston 30, and is disposed coaxially around the third partition wall 223′ so as to define an annular third upper gas chamber 225″ between the third and fourth partition walls 223′, 223″. The axial length of the fourth partition wall 223″ is equal to that of the third partition wall 223′. The third fence 32″ extends from the inner side surface of the plate body 301 into the third upper gas chamber 225″, and is disposed coaxially around the second fence 32′. The second and third fences 32′, 32″ define an annular third lower gas chamber 34″ therebetween. The axial length of the third fence 32″ is equal to that of the second fence 32′. Clearances are formed between the third fence 32″ and the third partition wall 223′, and between the third fence 32″ and the fourth partition wall 223″. This prevents contact between the third fence 32″ and the third partition wall 223′, and between the third fence 32″ and the fourth partition wall 223″. The third upper gas chamber 225″ and the third lower gas chamber 34″ form portions of the surrounding chamber unit.

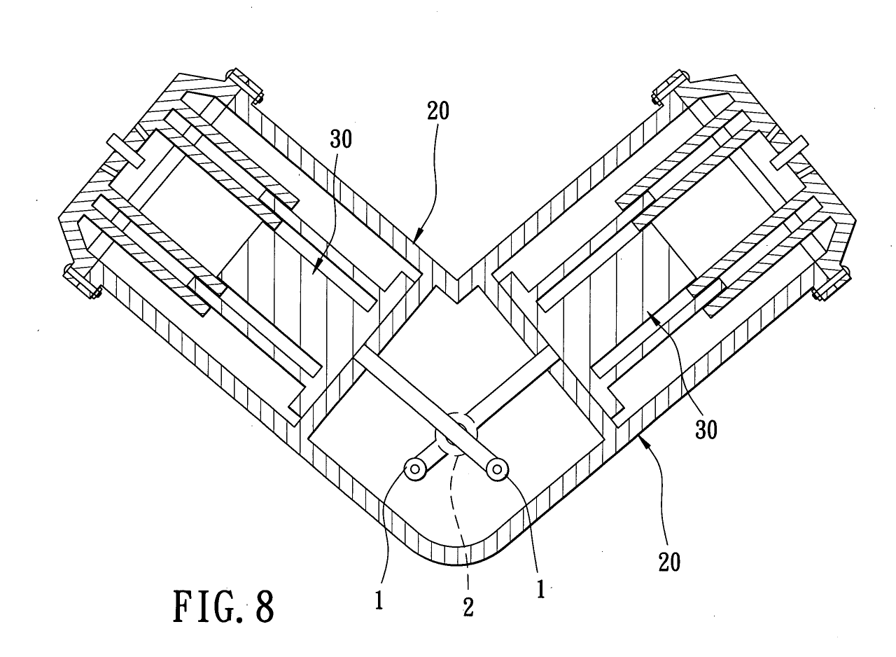

FIG. 8 shows the fourth preferred embodiment of an energy conversion device according to this invention, which is similar in construction to the first preferred embodiment except that this embodiment is configured as a two-cylinder engine. The two-cylinder engine includes two gas cylinders each consisting of a cylinder body 20 and a piston 30. Each of the pistons 30 is connected to a crankshaft 2 by a connecting rod 1. The two gas cylinders are interconnected obliquely so that the two-cylinder engine is generally V-shaped. Alternatively, the two gas cylinders may be parallel to or aligned with each other. In addition, the number of the gas cylinders may be increased.

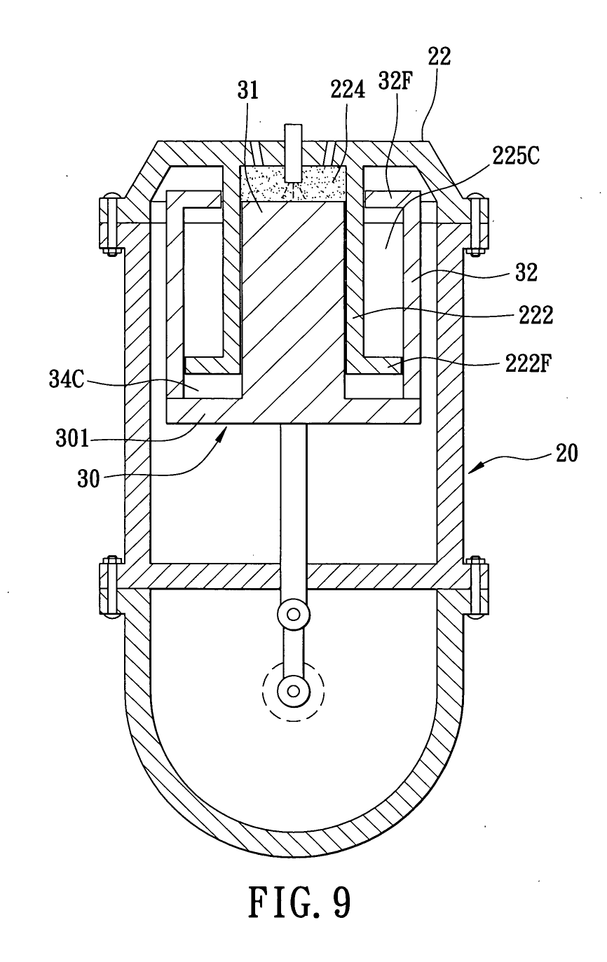

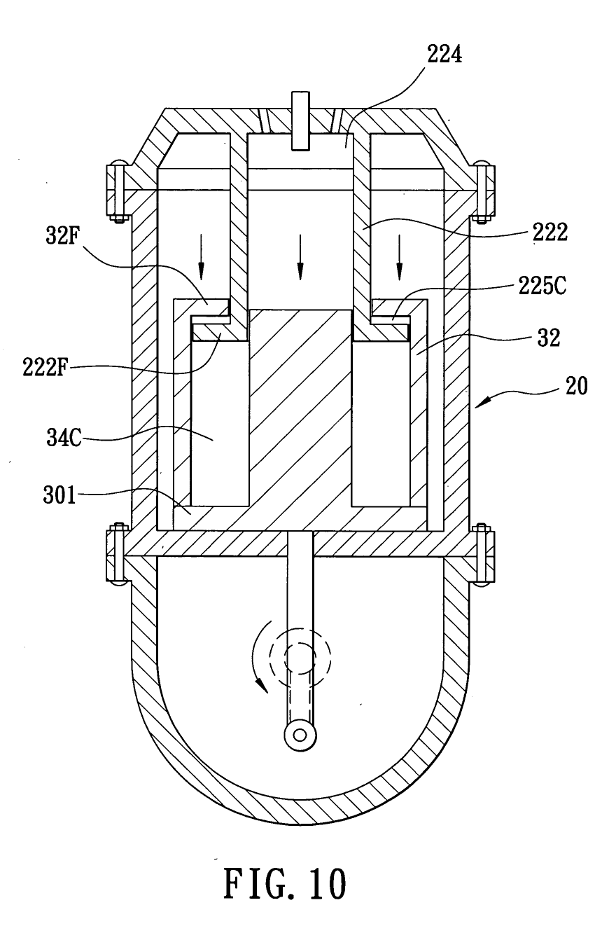

FIGS. 9 and 10 show the fifth preferred embodiment of an energy conversion device according to this invention. Unlike the first preferred embodiment, the partition wall unit includes an annular partition wall 222 that is formed with a radially and outwardly extending outward flange (222F) at an end distal from the base plate 22, and the fence unit includes an annular fence 32 that is formed with a radially and inwardly extending inward flange (32F) at an end distal from the plate body 301. The partition wall 222 extends from the inner side surface of the base plate 22 toward the piston 30. The piston chamber 224 is defined within the partition wall 222.

The fence 32 extends from the plate body 301 toward the base plate 22. Clearances are formed between the fence 32 and the outward flange (222F) and between the partition wall 222 and the inward flange (32F). As such, an annular lower gas chamber (34C) is defined among the plug 31, the plate body 301, the fence 32 and the outward flange (222F), and an annular upper gas chamber (225C) is defined among the fence 32, the partition wall 222, the inward flange (32F) and the outward flange (222F). When the plug 31 moves toward the base plate 22, gas within the lower gas chamber (34C) is compressed to thereby prevent escape of gas from the piston chamber 224. When the plug 31 moves away from the base plate 22, gas within the upper gas chamber (225C) is compressed to thereby prevent escape of gas from the piston chamber 224.

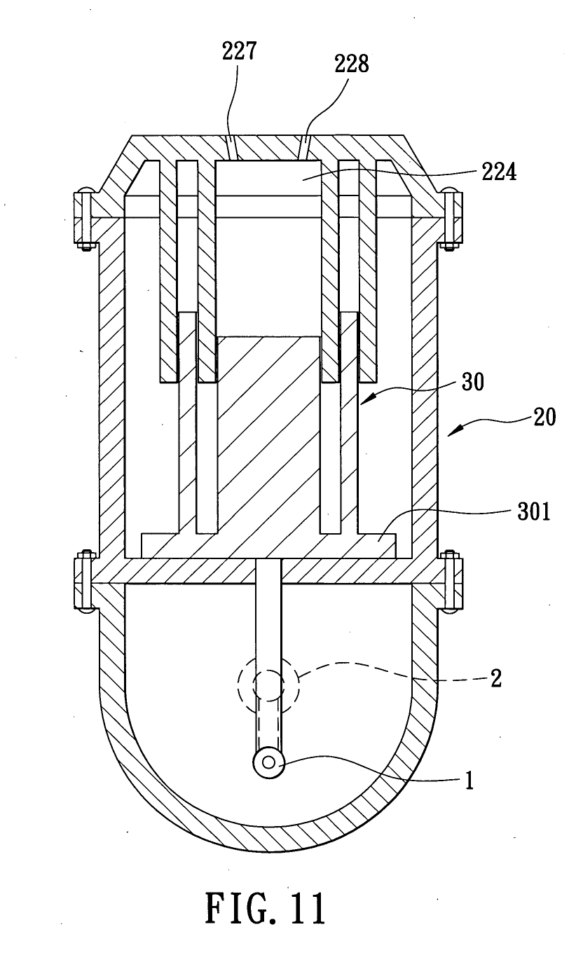

FIG. 11 shows the sixth preferred embodiment of an energy conversion device according to this invention, which is similar in construction to the first preferred embodiment except for the omission of the ignition member 226 (see FIG. 2) and which serves as an air compressor. In this embodiment, rotation of the crankshaft 2 can be converted into straight reciprocal movement of the piston 30.

With this invention thus explained, it is apparent that numerous modifications and variations can be made without departing from the scope and spirit of this invention. It is therefore intended that this invention be limited only as indicated by the appended claims.

I claim:

1. An energy conversion device comprising a gas cylinder, a shaft-supporting body and a crankshaft that is journalled within said shaft-supporting body, said gas cylinder including:
a cylinder body connected fixedly to said shaft-supporting body and including a base plate having an inner side surface that is formed with an annular partition wall unit, which extends integrally from said base plate along an axial direction of said cylinder body and which defines a cylindrical piston chamber therein;
a piston connected to said crankshaft so as to allow for conversion between straight reciprocal movement of said piston within said cylinder body and rotation of said crankshaft relative to said cylinder body, said piston including a plate body having an inner side surface that is formed with a cylindrical plug and a fence unit disposed coaxially around and spaced apart from said plug, said plug extending integrally from a center of said plate body toward said base plate of said cylinder body and being movable within said piston chamber in said cylinder body, said plug being coaxial with said partition wall unit of said cylinder body and having a diameter that is slightly smaller than an inner diameter of said partition wall unit such that an annular clearance is formed between said plug and said partition wall unit of said cylinder body and such that contact between said plug and said partition wall unit is prevented, said fence unit being spaced apart from said partition wall unit of said cylinder body, said plug and said fence unit cooperating with said partition wall unit of said cylinder body so as to define a surrounding chamber unit thereamong , said surrounding chamber unit of said cylinder body being adjacent to and communicated with said annular clearance between said plug and said partition wall unit, said partition wall unit and said fence unit being constructed so as to enable compression of gas in said surrounding chamber unit when said plug moves toward said base plate, thereby preventing escape of gas from said piston chamber; and
a guiding unit for guiding said piston to move within said cylinder body along said axial direction of said cylinder body.

2. The energy conversion device as claimed in claim 1, wherein said cylinder body is formed with an intake port and an exhaust port so that said energy conversion device serves as a gas compressor.

3. The energy conversion device as claimed in claim 1, wherein said cylinder body further includes an ignition member so that said energy conversion device serves as a single-cylinder engine.

4. The energy conversion device as claimed in claim 1, wherein said cylinder body is formed with a hole, and said plate body of said piston has an outer side surface that is opposite to said inner side surface of said plate body and that is formed with a fixed guide rod, said guide rod engaging fittingly and being movable within said hole in said cylinder body so as to guide said piston to move along said axial direction of said cylinder body.

5. The energy conversion device as claimed in claim 1, wherein
said partition wall unit of said cylinder body includes a pair of coaxial annular first and second partition walls, said first partition wall defining said piston chamber therein and being surrounded by said second partition wall, said first and second partition walls defining an annular first upper gas chamber therebetween; and
said fence unit of said piston includes an annular first fence disposed coaxially around and spaced apart from said plug so as to define an annular first lower gas chamber between said plug and said first fence, said first upper gas chamber and said first lower gas chamber constituting said surrounding chamber unit, said plug being coaxial with said first and second partition walls and having a diameter that is slightly smaller than an inner diameter of said first partition wall such that an annular clearance is formed between said plug and said first partition wall and such that contact between said plug and said first partition wall is prevented, said first fence extending into said first upper gas chamber such that annular clearances are formed between said first fence and said first partition wall and between said first fence and said second partition wall, thereby preventing contact between said first fence and said first partition wall and between said first fence and said second partition wall, said first fence having an axial length greater than that of said plug.

6. The energy conversion device as claimed in claim 5, wherein
said partition wall unit of said cylinder body further includes an annular third partition wall extending from said inner side surface of said base plate toward said piston and disposed coaxially around said second partition wall so as to define an annular second upper gas chamber between said second and third partition walls, said third partition wall having an axial length equal to that of said second partition wall; and
said fence unit of said piston further includes an annular second fence extending from said inner side surface of said plate body into said second upper gas chamber and disposed coaxially around said first fence so as to define an annular second lower gas chamber between said first and second fences, said second upper gas chamber and said second lower gas chamber constituting portions of said surrounding chamber unit, said second fence extending into said second upper gas chamber such that annular clearances are formed between said second fence and said second partition wall and between said second fence and said third partition wall, thereby preventing contact between said second fence and said second partition wall and between said second fence and said third partition wall.

7. The energy conversion device as claimed in claim 6, wherein
said partition wall unit of said cylinder body further includes an annular fourth partition wall extending from said inner side surface of said base plate toward said piston and disposed coaxially around said third partition wall so as to define an annular third upper gas chamber between said third and fourth partition walls, said fourth partition wall having an axial length equal to that of said third partition wall; and
said fence unit of said piston further includes an annular third fence extending from said inner side surface of said plate body into said third upper gas chamber and disposed coaxially around said second fence so as to define an annular third lower gas chamber between said second and third fences, said third upper gas chamber and said third lower gas chamber constituting portions of said surrounding chamber unit, said third fence extending into said third upper gas chamber such that annular clearances are formed between said third fence and said third partition wall and between said third fence and said fourth partition wall, thereby preventing contact between said third fence and said third partition wall and between said third fence and said fourth partition wall.

8. The energy conversion device as claimed in claim 1, wherein
said partition wall unit of said cylinder body includes a cylindrical partition wall defining said piston chamber therein and extending from said inner side surface of said base plate toward said piston, said partition wall having an end that is distal from said base plate and that is formed with an outward flange extending radially and outwardly therefrom; and
said fence unit of said piston includes an annular fence extending from said plate body toward said base plate and coaxial with said partition wall, said fence being spaced apart from and adjacent to said outward flange of said partition wall and having an end that is distal from said plate body and that is formed with an inward flange extending radially and inwardly therefrom, said inward flange being spaced apart from and adjacent to said partition wall so as to define both an annular lower gas chamber among said plug, said plate body, said fence and said outward flange, and an annular upper gas chamber among said fence, said partition wall, said inward flange and said outward flange, said upper and lower gas chambers constituting said surrounding chamber unit, gas within said lower gas chamber being compressed to thereby prevent escape of gas from said piston chamber when said plug moves toward said base plate, gas being compressed within said upper gas chamber so as to prevent escape of gas from said piston chamber when said plug moves away from said base plate.

9. An energy conversion device comprising two gas cylinders, a shaft-supporting body and a crankshaft, each of said gas cylinders including:
a cylinder body connected fixedly to said shaft-supporting body and including a base plate having an inner side surface that is formed with an annular partition wall unit, which extends integrally from said base plate along an axial direction of said cylinder body and which defines a cylindrical piston chamber therein;
a piston connected to said crankshaft so as to allow for conversion between straight reciprocal movement of said piston within said cylinder body and rotation of said crankshaft relative to said cylinder body, said piston including a plate body having an inner side surface that is formed with a cylindrical plug and a fence unit disposed coaxially around and spaced apart from said plug, said plug extending integrally from a center of said plate body toward said base plate of said cylinder body and being movable within said piston chamber in said cylinder body, said plug being coaxial with said partition wall unit of said cylinder body and having a diameter that is slightly smaller than an inner diameter of said partition wall unit such that an annular clearance is formed between said plug and said partition wall unit and such that contact between said plug and said partition wall unit of said cylinder body is prevented, said fence unit being spaced apart from said partition wall unit of said cylinder body, said plug and said fence unit cooperating with said partition wall unit of said cylinder body so as to define a surrounding chamber unit thereamong, said surrounding chamber unit of said cylinder body being adjacent to and communicated with said annular clearance between said plug and said partition wall unit, said partition wall unit and said fence unit being constructed so as to enable compression of gas in said surrounding chamber unit when said plug moves toward said base plate, thereby preventing escape of gas from said piston chamber; and
a guiding unit for guiding said piston to move within said cylinder body along said axial direction of said cylinder body.

10. A gas cylinder comprising:
a cylinder body including a base plate having an inner side surface that is formed with an annular partition wall unit, which extends integrally from said base plate along an axial direction of said cylinder body and which defines a cylindrical piston chamber therein;
a piston connected to said crankshaft so as to allow for conversion between straight reciprocal movement of said piston within said cylinder body and rotation of said crankshaft relative to said cylinder body, said piston including a plate body having an inner side surface that is formed with a cylindrical plug and a fence unit disposed coaxially around and spaced apart from said plug, said plug extending integrally from a center of said plate body toward said base plate of said cylinder body and being movable within said piston chamber in said cylinder body, said plug being coaxial with said partition wall unit of said cylinder body and having a diameter that is slightly smaller than an inner diameter of said partition wall unit such that an annular clearance is formed between said plug and said partition wall unit and such that contact between said plug and said partition wall unit is prevented, said fence unit being spaced apart from said partition wall unit of said cylinder body, said plug and said fence unit cooperating with said partition wall unit of said cylinder body so as to define a surrounding chamber unit thereamong, said surrounding chamber unit of said cylinder body being adjacent to and communicated with said annular clearance between said plug and said partition wall unit, said partition wall unit and said fence unit being constructed so as to enable compression of gas in said surrounding chamber unit when said plug moves toward said base plate, thereby preventing escape of gas from said piston chamber; and
a guiding unit for guiding said piston to move within said cylinder body along said axial direction of said cylinder body.
